(19) United States
(12) Patent Application Publication
(10) Pub. No.: US 2014/0096689 A1
(43) Pub. Date: Apr. 10, 2014

(54) FOOD WARMER

(71) Applicant: Team Kalorik Group N.V., Sint-Genesius-Rode (BE)

(72) Inventor: Michael Stolle, Bruessel (BE)

(73) Assignee: Team Kalorik Group N.V., Sint-genesius-Rode (BE)

(21) Appl. No.: 14/044,949

(22) Filed: Oct. 3, 2013

(30) Foreign Application Priority Data
Oct. 5, 2012 (EP) 12187476.2

(51) Int. Cl. A47J 39/00

(52) U.S. Cl. CPC A47J 39/006; A47J 39/003
USPC 99/483

(57) ABSTRACT

A device for heating or keeping food warm. The device comprises a housing having at least one opening for inserting or removing food, an interior space formed by the housing, and at least one electromagnetic radiation source disposed in the interior space of the housing for emitting the heat radiation. The device is characterized in that the housing comprises a cooling device for cooling at least part of the housing. Advantageously, the cooling device comprises ventilation means for generating an air current which forms a curtain of warm air by means of which it becomes considerably more difficult or impossible for particles or microorganisms to enter the interior space.

### FIELD OF INVENTION

The invention concerns a device for heating or keeping food warm by means of an electromagnetic radiation source for emitting heat radiation.

### BACKGROUND OF THE INVENTION

Devices for heating or keeping food warm (the food is typically located on or in a container for cooking or serving, e.g., a dish) are used in the field of gastronomy, for example in fast food restaurants. Aside from heating and keeping food warm, such devices can also contribute to the attractive presentation of food. In addition to conventional electric heating elements, such as heating coils made of metal that can be heated, electromagnetic radiation sources, particularly infrared lamps, have come into use, which subject the food to infrared electromagnetic radiation.

The advantage of using electromagnetic radiation sources is that such sources provide higher energy efficiency, a uniform heat distribution and the simultaneous illumination of the food.

A food display that can be heated by means of infrared lamps is disclosed in GB 2 349 454 A, in which a specially designed radiating panel in front of the radiation source provides for a favorable radiation characteristic of the electromagnetic radiation. In order to protect operating personnel from possible injury through contact with hot housing components, it is proposed that metal or wire mesh screens surround the hot regions, or that the food is placed on nylon trays.

EP 2 286 701 A1 and US 2011/0252813 A1 describe devices for keeping food warm. Both documents mention that the heating elements (halogen lamps or Peltier elements) can be cooled by means of an air current. However, the air cooling system described therein provides insufficient cooling for the housing, especially in the front area where the foods are supplied and removed.

Aside from the danger of injury through coming into contact with hot housing components, there is a further disadvantage in that germs can enter the storage zone through the open front end of the food display. This is a problem, in particular, during prolonged presentation of the food, and for those regions of the storage zones having only moderate holding temperatures.

It is an objective of the present invention to provide a device of the above-mentioned type, which reduces the disadvantages described above and which meets higher demands with regard to hygiene and workplace safety.

According to the present invention, this objective is attained by means of a device having the features of the independent claim(s). Advantageous designs and further developments can be derived from the dependent claims.

### SUMMARY OF THE INVENTION

The present invention provides a device for heating and keeping food warm that comprises a housing having at least one opening for loading or removing the food, an interior space formed by the housing, and at least one electromagnetic radiation source for emitting heat radiation. The at least one electromagnetic radiation source is arranged in the interior space of the housing. According to the present invention, the device is characterized in that the housing comprises a cooling device for cooling one or more parts of the housing. Preferably, at least those parts of the housing that the operator can come in contact with when loading or removing food are cooled. The housing can be made of a wide variety of materials, but is typically made, at least in part, of stainless steel.

The cooling device can comprise an electric cooling system, which includes, for example, Peltier elements or a coolant system having a heat exchanger. However, in many cases the ambient air passing over the parts of the housing that are to be cooled already acts as an effective coolant. For this reason, the cooling device advantageously comprises ventilation means, which draw air from the surrounding area and conveys the air along the parts of the housing that are to be cooled. In the context of the present invention, “ventilation means” comprise, in particular, rotating fans, designed, for example, as a tangential or cylindrical fan. The parts of the housing that are to be cooled typically comprise at least a part of the housing that surrounds the at least one opening.

According to the present invention, the ventilation means generate an air current that runs substantially parallel to a plane that extends across the opening. In particular, the air current can be directed vertically downward toward the lower boundary of the opening. In the context of the present invention, “substantially parallel” means that a small angle may exist between the plane that extends across the opening and the air current running past the plane. The air current, in general, is not perfectly parallel, but instead, diverges slightly in its path from the ventilation means. This air current, which is heated through contact with the parts of the housing that are to be cooled, forms, to some extent, a “warm air curtain” at the opening of the housing, which prevents colder ambient air from entering the interior space of the housing. As a result, the food that is to be heated is prevented from cooling off, and it becomes difficult or impossible for particles or microorganisms and other contaminants from the surrounding area to enter the interior space having the food located therein.

In a further development of the device according to the present invention, the at least one opening is disposed on the front side of the housing. The ventilation means can be disposed thereby in a crossbar that defines the top boundary of the at least one opening.

In one embodiment of the device according to the present invention, the interior space is divided by intermediate shelves into multiple compartments that are spaced in a substantially vertical orientation, wherein an opening is associated with each compartment. In the context of the present invention, “substantially vertical” means that the compartments may be oriented at a slight inclination. For example, compartment shelves that are slightly inclined with respect to a horizontal direction make it possible that the individual compartments can be loaded with food through a loading opening, which then slide along the inclination of the compartment shelf toward a removal opening on the opposite side. In this case, both the loading opening, as well as the removal opening, can be provided with a warm air curtain of the type described above. Each of the compartments can form a separate interior space and can include one or more electromagnetic radiation sources and ventilation means. Moreover, the openings can be closable by means of flaps or covers.

In a further development of the device according to the present invention, the air current also flows in a substantially horizontal direction into the interior space, wherein in the context of the invention, “substantially horizontal” allows for a slight inclination of the compartments. The air current flows, thereby, either along the upper inner wall of the housing and/or the lower surface of the intermediate shelves or through channels formed in the upper inner wall of the housing and/or in the intermediate shelves. In doing so, the air current at the rear side of the housing is deflected downward.

The ventilation means in the device according to the present invention can comprise a ventilation element, which includes a ventilation fan mounted in a hollow chamber provided with ventilation vents.

Typically, the electromagnetic radiation source is attached to, or integrated in, the upper inner wall of the housing and/or the lower sides of the intermediate shelves. The number of electromagnetic radiation sources and the positioning thereof can be adapted thereby to the demands, for example, the distribution of the food that is to be kept warm, or the cost of the device.

Advantageously, the electromagnetic radiation source is designed as a halogen lamp and can emit one or more wavelength ranges in the infrared spectrum. The electromagnetic radiation source is, in particular, optimized for the wavelength ranges which preferably are absorbed by food, for example, in the microwave range. The spectral components can comprise a range in the visible light spectrum, for illuminating the food.

A preferred embodiment provides a temperature control system for controlling the electromagnetic radiation source for emitting heat radiation and/or for controlling the cooling device. Preferably, the temperature control system comprises at least one temperature sensor for measuring the temperature in the interior space of the housing. For example, the temperature sensor can be located in the floor or intermediate shelf of the housing.

The invention shall now be explained in greater detail, based on preferred embodiments, with reference to the attached drawings.

### BRIEF DESCRIPTION OF THE DRAWINGS

FIG. 1 shows a perspective view of an embodiment example of the device according to the present invention;

FIGS. 2a and 2b show sectional views of two embodiment examples of the device according to the present invention;

FIG. 3a shows a partially disassembled ventilation element, as it can be incorporated in a ventilation means for the device according to the present invention;

FIG. 3b shows the ventilation element from FIG. 3a, in its assembled state; and

FIG. 4 illustrates the air current in an advantageous embodiment example of the device according to the present invention.

### DETAILED DESCRIPTION OF THE INVENTION

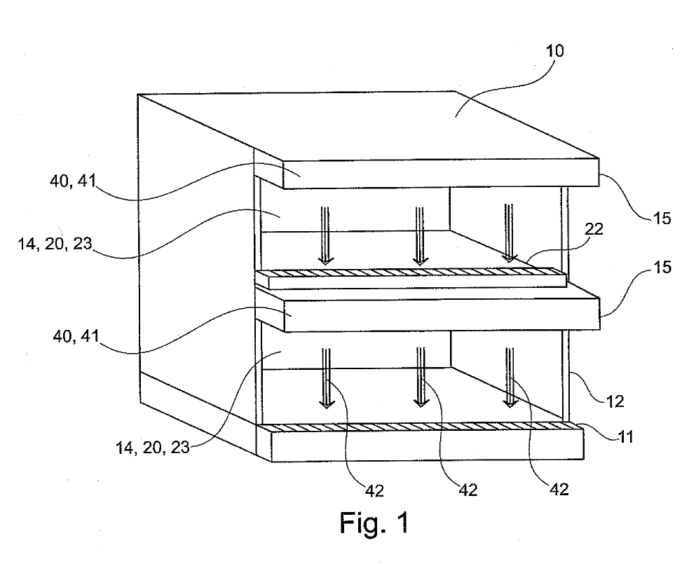

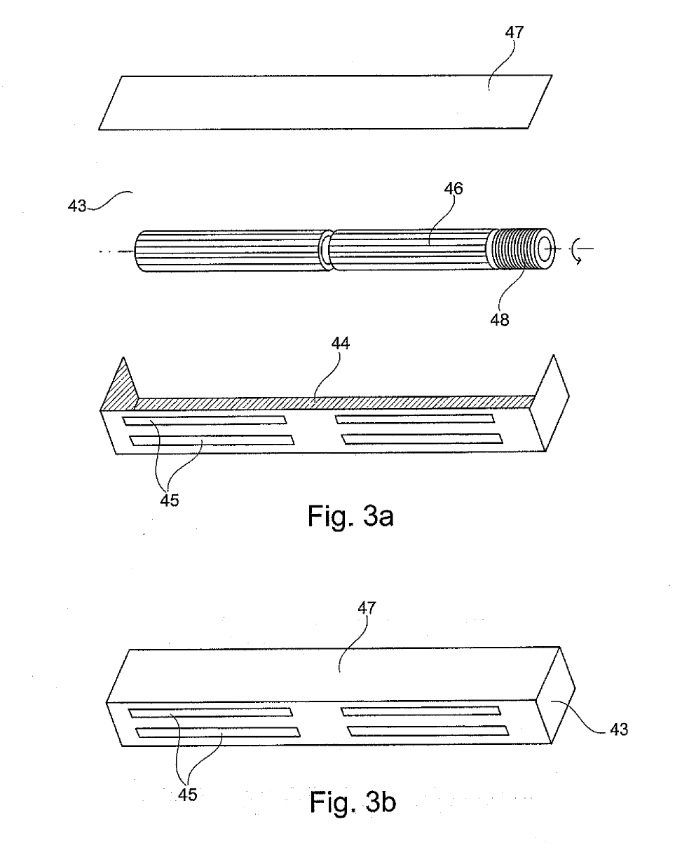

In FIG. 1, a device according to the present invention, for heating or keeping food warm, is depicted. It will be appreciated that the food may be located on or in a container for cooking or serving the food (e.g., a dish). The perspective view shows a housing 10, on a front side 12 of which compartments 23 are visible through two openings 14. The compartments 23 form an interior space 20 of the housing 10. The upper edge of each opening 14 contains a crossbar 15, on which a cooling device 40, in particular a ventilation means 41, can be mounted. 100261 Through ventilation vents 45, best seen in FIGS. 3a and 3b, an air current 42 generated by the ventilation means 41 can be directed downward, parallel to the plane that extends across the opening 14. At the lower boundary of the opening 14, the air current 42 flows over one or more parts 11 of the housing 10 that are to be cooled. These parts 11 of the housing 10 represent, in particular, sources of danger to the operating personnel that, through inattentive reaching into the interior space 20, may bum the operating personnel. The air current 42 can be adjusted such that, on one hand, the temperature in the interior space 20 is high enough to keep the food warm, and on the other hand, is cool enough that the operating personnel will not burn themselves on the parts 11 that are to be cooled. By guiding the air current 42 substantially parallel to the plane that extends across the opening 14, it is possible to simultaneously prevent an excess of heat from being discharged into the surroundings from the interior space 20 through convection.

Electromagnetic radiation sources 30 are mounted on an upper inner wall 21 of the housing 10 and/or the undersurfaces of intermediate shelves 22, which are hidden here, due to the perspective view. The present device can exhibit numerous other features for the presentation of food, which are not depicted here, for reasons of clarity. These comprise, in particular, additional lighting possibilities, as well as labels for the food, for the customers or the operating personnel.

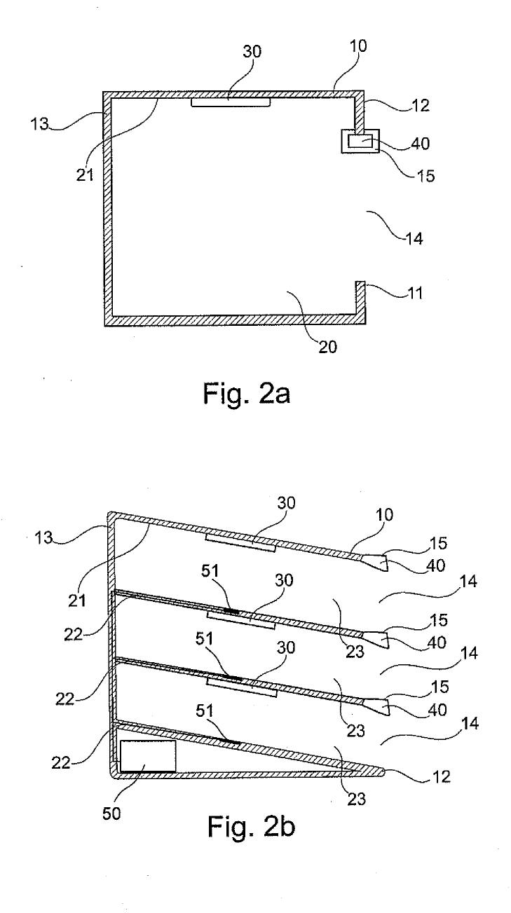

A sectional view of a simple embodiment of the device according to the present invention is shown in FIG. 2a. The housing 10 encompasses interior space 20, which can be accessed by means of opening 14. A cooling device 40 is mounted on a crossbar 15 defining a top boundary of opening 14. The electromagnetic radiation source 30 is attached to the upper inner wall 21 of the housing 10.

A sectional view of another embodiment of the device according to the present invention is shown in FIG. 2b. In this example, the interior space 20 is divided into three compartments 23 by means of intermediate shelves 22. Each of the compartments 23 has one opening 14 with integrated cooling device 40 at the front side 12, and its own electromagnetic radiation source 30, attached beneath the intermediate shelves 22 or the upper inner wall 21 in each case. A temperature control system 50 for controlling the electromagnetic radiation source 30 and/or for controlling the cooling device 40 is provided in the housing 10. The temperature control system 50 comprises numerous temperature sensors 51 in the depicted example, for measuring the temperature in the interior space 20 of the housing 10. The temperature sensors 51 are built into the upper surfaces of the intermediate shelves 22, such that each compartment 23 can be controlled individually.

A ventilation element 43 is shown in FIG. 3a, in the form in which it can comprise a ventilation means 41 integrated in crossbar 15, as shown in FIGS. 1, 2a, and 2b. In a partially disassembled state in FIG. 3a, with a panel 47 removed, it is possible to see into a hollow chamber 44 behind the panel 47, in which a blower 46 is located. The blower 46 typically comprises a blower motor 48, and is designed as a tangential ventilator in the depicted example. The ventilation vents 45 provided on the lower surface of the ventilation element 43 enable a uniform air current 42 away from the ventilation element 43 when the blower 46 is rotating. The ventilation element 43 is depicted in the assembled state in FIG. 3b.

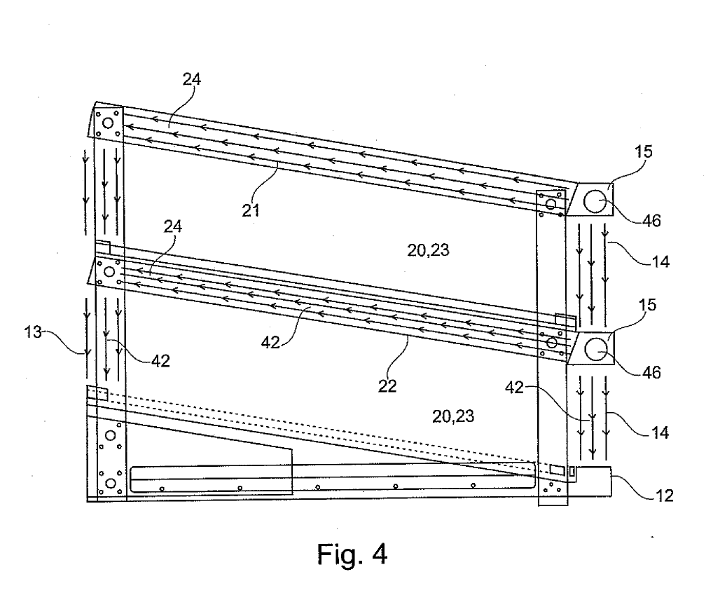

The advantageous embodiment of the device according to the invention depicted in FIG. 4 illustrates air currents 42 caused by the ventilation means 41, in a lateral section. The blowers 46 integrated in the crossbars 15, cause, on one hand, air currents 42 guided downward, which cover the openings 14 at the front side 12, and on the other hand, generate additional air currents 42 in the interior space 20 of the housing 10, parallel to the intermediate shelves 22 and to the upper inner wall 21. The air currents 42 flowing against back side 13 of the housing 10 in the interior space 20 are deflected downward.

The air currents 42, directed downward to both the front side 12 as well as the back side 13 of the housing 10, cause the interior space 20 and thus the storage areas lying in the compartments 23 to be surrounded by a warm air curtain. This warm air curtain makes it difficult, on one hand, for particles and microorganisms to enter the storage area, and on the other hand, prevents excessive heating in the region of the opening 14 of the housing 10, by means of which, the danger of the operating personnel burning themselves on the housing 10 is reduced.

As can be readily seen, through an appropriate design of the upper inner wall 21 and the intermediate shelves 22, channels 24 can be formed, by means of a double floor, or flow grooves in the respective components, for example. The channels 24 can thus act against a divergence of the air current 42, and contribute to an effective warm air curtain on the back side 13 of the housing 10 as well.

Having described the invention, the following is claimed:

1. A device for heating or keeping food warm, comprising:
a housing with at least one opening for loading or removing the food,
an interior space formed by the housing, and
at least one electromagnetic radiation source for emitting heat radiation, said at least one electromagnetic radiation source disposed in the interior space of the housing,
wherein the housing comprises a cooling device for cooling one or more parts of the housing, said cooling device including ventilation means to draw air from a surrounding area along the parts of the housing to be cooled, wherein the ventilation means generate an air current that runs substantially parallel to a plane that extends across the at least one opening of the housing.

2. Device according to claim 1, wherein the parts of the housing to be cooled comprises at least a part of the housing that surrounds the at least one opening.

3. Device according to claim 1, wherein the at least one opening is located at a front side of the housing, and the ventilation means are arranged in a crossbar that defines the upper boundary of the at least one opening.

4. Device according to claim 1, wherein the air current from the ventilation means is directed vertically downward toward a lower boundary of the opening.

5. Device according to claim 1, wherein the interior space is divided by intermediate shelves into compartments that are spaced in a substantially vertical orientation, wherein an opening is associated with each compartment.

6. Device according to claim 1, wherein the air current from the ventilation means runs in a substantially horizontal direction into the interior space, wherein the air current flows either:
(a) along an upper inner wall of the housing and/or lower sides of intermediate shelves, or
(b) through channels formed in the upper inner wall of the housing and/or in the intermediate shelves;
and is deflected downward at a back side of the housing.

7. Device according to claim 1, wherein the ventilation means include a ventilation element having a blower disposed in a hollow chamber and ventilation vents formed in said ventilation element.

8. Device according to claim 1, wherein the at least one electromagnetic radiation source is attached
(a) at an upper inner wall of the housing and/or at lower sides of intermediate shelves, or
(b) integrated into said upper inner wall and said intermediate shelves.

9. Device according to claim 1, wherein the electromagnetic radiation source includes a halogen lamp.

10. Device according to claim 1, wherein said device further comprises a temperature control system for controlling the at least one electromagnetic radiation source for emitting heat radiation and/or for controlling the cooling device.

11. Device according to claim 10, wherein the temperature control system comprises at least one temperature sensor for measuring the temperature in the interior space of the housing.
